(19) United States
(12) Patent Application Publication
(10) Pub. No.: US 2022/0058840 A1
(43) Pub. Date: Feb. 24, 2022

(54) IMAGE PROCESSING APPARATUS, IMAGE PROCESSING METHOD, AND NON-TRANSITORY COMPUTER-READABLE STORAGE MEDIUM STORING IMAGE PROCESSING PROGRAM

(71) Applicant: Seiko Epson Corporation, Tokyo (JP)

(72) Inventor: Yuya HAYAMI, Matsumoto-shi (JP)

(21) Appl. No.: 17/409,252

(22) Filed: Aug. 23, 2021

(30) Foreign Application Priority Data
Aug. 24, 2020 (JP) 2020-141246

(51) Int. Cl. G06T 11/00; H04N 1/60; G06T 15/20; G06T 17/20

(52) U.S. Cl. CPC G06T 11/001; H04N 1/6058; G06T 17/20; G06T 15/20; H04N 1/6075; H04N 1/6019

(57) ABSTRACT

An image processing apparatus includes: a display control section that causes a display device to display an image indicating a state in which a figure indicating a color gamut, a dot indicating a designated color, and one or more axes each indicating a feature amount of a color are viewed in an identical three-dimensional color space from a predetermined viewpoint; and a receiving section that receives an instruction issued by a user. The display control section changes, in accordance with the instruction, the image upon changing the viewpoint.

The present application is based on, and claims priority from JP Application Serial Number 2020-141246, filed Aug. 24, 2020, the disclosure of which is hereby incorporated by reference herein in its entirety.

### BACKGROUND

### 1. Technical Field

The present disclosure relates to an image processing apparatus, an image processing method, and a non-transitory computer-readable storage medium storing an image processing program.

### 2. Related Art

For color matching between devices that handle color, an ICC (International Color Consortium) profile in which coordinate values of a device-dependent CMYK color space or the like and coordinate values of the device-independent CIELAB color space or the like are associated with each other is typically used.

In business fields such as the printing industry, since it is desirable to output a designated color as accurately as possible, users desire to know whether or not designated colors are within an ICC profile color gamut and, when the designated color is not within the ICC profile color gamut, the extent to which the designated color is out of the color gamut.

JP-A-2010-213229 discloses a technique of displaying shapes of a color gamut of an input device and a color gamut of an output device in an identical color space.

However, in the technique described in JP-A-2010-213229, since color gamuts viewed from a fixed viewpoint are displayed, it is difficult for a user to know the relationship between the color gamut of the input device and the color gamut of the output device across the entire range. Thus, depending on the designated color, the technique described in JP-A-2010-213229 has a problem in that it is difficult to determine the relationship between the designated color and the ICC profile color gamut.

### SUMMARY

An image processing apparatus according to an aspect of the disclosure includes: a display control section that causes a display device to display an image indicating a state in which a figure indicating a color gamut, a dot indicating a designated color, and one or more axes each indicating a feature amount of a color are viewed in an identical three-dimensional color space from a predetermined viewpoint; and a receiving section that receives an instruction issued by a user. The display control section changes, in accordance with the instruction, the image upon changing the viewpoint.

An image processing method according to an aspect of the disclosure includes: causing a display device to display an image indicating a state in which a figure indicating a color gamut, a dot indicating a designated color, and one or more axes each indicating a feature amount of a color are viewed in an identical three-dimensional color space from a predetermined viewpoint; receiving an instruction issued by a user; and changing, in accordance with the instruction, the image upon changing the viewpoint.

In a non-transitory computer-readable storage medium storing an image processing program according to an aspect of the disclosure, the image processing program causes a computer to execute: causing a display device to display an image indicating a state in which a figure indicating a color gamut, a dot indicating a designated color, and one or more axes each indicating a feature amount of a color are viewed in an identical three-dimensional color space from a predetermined viewpoint; receiving an instruction issued by a user; and changing, in accordance with the instruction, the image upon changing the viewpoint.

### BRIEF DESCRIPTION OF THE DRAWINGS

FIG. 1 is a schematic view illustrating an example of a configuration of a system in which an image processing apparatus according to an embodiment is used.

FIG. 2 is a flowchart of an image processing method according to the embodiment.

FIG. 3 is a diagram for explaining an example of an ICC profile.

FIG. 4 illustrates an example of an image to be displayed on a display device by using the image processing apparatus.

FIG. 5 is a schematic view for explaining a comparison between a color gamut and a designated color.

FIG. 6 illustrates an example of an image in which the color gamut is displayed as a surface model.

FIG. 7 illustrates an example of an image when the color gamut is not displayed.

### DESCRIPTION OF EXEMPLARY EMBODIMENTS

A preferred embodiment according to the disclosure will be described below with reference to the accompanying drawings. Note that, in the drawings, dimensions or scales of sections differ appropriately from actual ones, and some sections are schematically illustrated for ease of understanding. The scope of the disclosure is not limited to the embodiment as long as there is no description particularly limiting the disclosure in the following description.

### 1. EMBODIMENT

1-1. Overview of System 100 in which Image Processing Apparatus 1 is Used

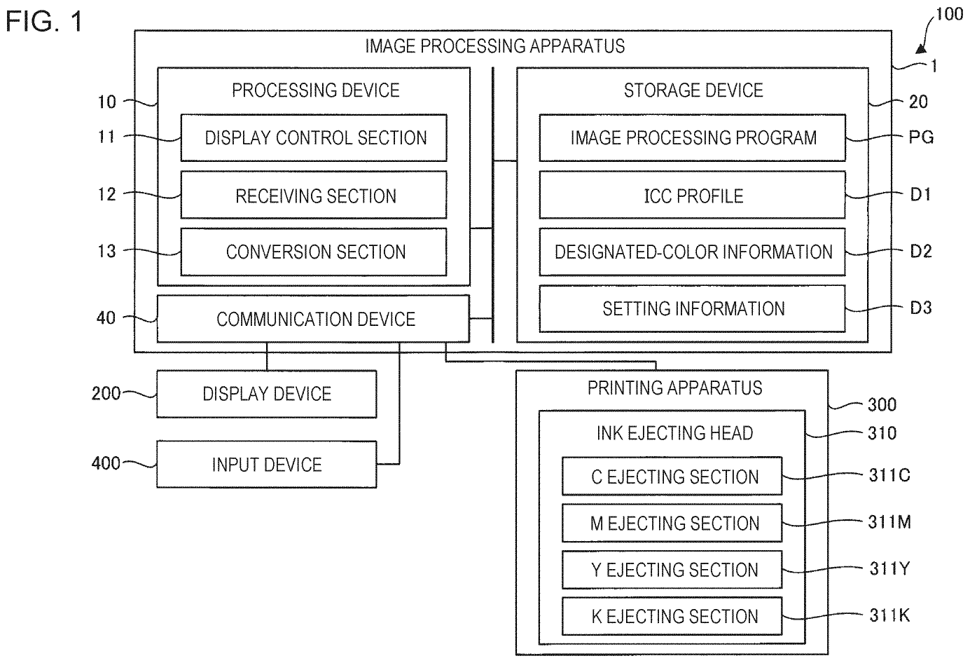

FIG. 1 is a schematic view illustrating an example of a configuration of the system 100 in which the image processing apparatus 1 according to the embodiment is used. The system 100 is a system for displaying a relationship between a color gamut of an ICC profile D1 and a color indicated by designated-color information D2.

The system 100 includes the image processing apparatus 1, a display device 200, a printing apparatus 300, and an input device 400. The image processing apparatus 1 is coupled to each of the display device 200, the printing apparatus 300, and the input device 400 so as to be able to communicate with each of them. Note that the printing apparatus 300 may be omitted.

The display device 200 is a device that performs display in accordance with control performed by the image processing apparatus 1. For example, the display device 200 is a display device that includes a display panel, and various types of display panel such as a liquid crystal display panel and an organic EL (electroluminescence) display panel may be used. Note that the display device 200 may be provided separately from or integrally with the image processing apparatus 1.

The printing apparatus 300 is an apparatus that performs printing on a printing medium in accordance with control performed by the image processing apparatus 1. The printing medium is not particularly limited, and, for example, various types of paper, various types of fabric, and various types of film may be used. In the example illustrated in FIG. 1, the printing apparatus 300 is an ink jet printer that includes an ink ejecting head 310 that ejects ink of four colors of cyan, magenta, yellow, and black. Note that, although not illustrated, in addition to the ink ejecting head 310, the printing apparatus 300 includes a transporting mechanism that transports the printing medium in a predetermined direction and a moving mechanism that iteratively moves the ink ejecting head 310 in an axial direction orthogonal to a direction in which the printing medium is transported.

The input device 400 is a device that receives a user operation. For example, the input device 400 may include a touch pad, a touch panel, or a pointing device such as a mouse. Here, when the input device 400 includes a touch panel, the input device 400 may also function as the display device 200.

The ink ejecting head 310 includes a C ejecting section 311C that ejects cyan ink, an M ejecting section 311M that ejects magenta ink, a Y ejecting section 311Y that ejects yellow ink, and a K ejecting section 311K that ejects black ink. Each of the ejecting sections ejects ink supplied from an ink container (not illustrated) onto the printing medium from a plurality of nozzles (not illustrated) in accordance with control performed by a processing device 10. More specifically, each of the ejecting sections includes a pressure chamber (not illustrated) and a driving element (not illustrated) for each of the nozzles and changes, by using the driving element, pressure in the pressure chamber to thereby eject the ink in the pressure chamber from a nozzle. The driving element is, for example, a piezoelectric element or a heating element. In the printing apparatus 300 described above, when reciprocation of the ink ejecting head 310 and the ink ejection are performed in parallel, an image is formed on a printing surface of the printing medium.

Note that the moving mechanism that causes the ink ejecting head 310 to be reciprocated may be omitted. In this case, for example, the ink ejecting head 310 may be provided over the whole area in a width direction orthogonal to the direction in which the printing medium is transported. Moreover, the number of colors of ink ejected by the ink ejecting head 310 is not limited to four in the aforementioned case and may be three or less or five or more.

The image processing apparatus 1 is a computer that causes the display device 200 to display an image according to the ICC profile D1 and the designated-color information D2. The image processing apparatus 1 of the present embodiment includes the aforementioned display function for displaying an image and also includes a printing function for performing printing with the printing apparatus 300 by using the ICC profile D1. Note that the printing function may be omitted. The configuration of the image processing apparatus 1 will be described below.

### 1-2. Configuration of Image Processing Apparatus 1

As illustrated in FIG. 1, the image processing apparatus 1 includes the processing device 10, a storage device 20, and a communication device 40. These are coupled to each other so as to enable communication.

The processing device 10 is a device that has a function of controlling the respective sections of the image processing apparatus 1 and a function of processing various kinds of data. The processing device 10 includes, for example, a processor such as a CPU (central processing unit). Note that the configuration of the processing device 10 may include a single processor or a plurality of processors. Moreover, some or all of the functions of the processing device 10 may be realized by hardware such as a DSP (digital signal processor), an ASIC (application specific integrated circuit), a PLD (programmable logic device), or an FPGA (field programmable gate array).

The storage device 20 is a device that stores various programs executed by the processing device 10 and various kinds of data processed by the processing device 10. The storage device 20 may include, for example, a hard disk drive or semiconductor memory. Note that a portion of the storage device 20 or the whole storage device 20 may be provided in a storage apparatus, a server, or the like outside the image processing apparatus 1.

The storage device 20 of the present embodiment stores an image processing program PG, the ICC profile D1, the designated-color information D2, and setting information D3. The image processing program PG is a program that causes the image processing apparatus 1 to perform an image processing method described later. The ICC profile D1 will be described later in detail. The designated-color information D2 is information related to a color value which is indicated by coordinate values of a device-dependent color space such as an RGB color space or a CMYK color space. The setting information D3 is information related to a setting of a display element such as a background color of an image based on the ICC profile D1 and the designated-color information D2 or a font. Note that, upon a user operation, the ICC profile D1, the designated-color information D2, and the setting information D3 are input to the image processing apparatus 1 in accordance with an instruction from a receiving section 12 described below. However, some or all of the setting information D3 is set in advance and is appropriately changed in accordance with an instruction from the receiving section 12.

The communication device 40 is an interface that is coupled to external devices such as the display device 200, the printing apparatus 300, and the input device 400 so as to enable communication. For example, the communication device 40 includes an interface such as USB (universal serial bus) or a LAN (local area network) interface. Note that the communication device 40 may be coupled to an external device in a wireless manner by using Wi-Fi, Bluetooth, or the like or may be coupled to an external device via the LAN (local area network), the Internet, or the like. Note that Wi-Fi and Bluetooth are registered trademarks.

In the image processing apparatus 1 having the above-described configuration, the processing device 10 reads the image processing program PG from the storage device 20 and executes the image processing program PG. By executing the image processing program PG, the processing device 10 functions as a display control section 11, the receiving section 12, and a conversion section 13.

The display control section 11 controls drive of the display device 200. Specifically, the display control section 11 causes the display device 200 to display an image according to the ICC profile D1 and the designated-color information D2. The image is, for example, an image G described below and indicates a state in which a figure indicating a color gamut of the ICC profile D1, a dot indicated by the designated-color information D2, and one or more axes each indicating a feature amount of a color are viewed in an identical three-dimensional color space from a predetermined viewpoint. Moreover, the display control section 11 changes the image in accordance with an instruction from the receiving section 12. Note that the feature amount of a color is an amount for indicating a feature of a color, and examples thereof include hue, saturation, and brightness.

The receiving section 12 receives a user instruction. Specifically, the receiving section 12 receives a user instruction via the input device 400. The instruction is issued by using an image GU, which will be described below, as a GUI (graphical user interface) that includes the image G. Moreover, the receiving section 12 appropriately changes the setting information D3 in accordance with the instruction. Specific content of the instruction will be described later in detail.

The conversion section 13 converts information such as the designated-color information D2 by using the ICC profile D1. Specifically, by using the ICC profile D1, the conversion section 13 converts coordinate values of a device-dependent color space such as an RGB color space or a CMYK color space into coordinate values of a device-independent color space such as the L*a*b* color space or the XYZ color space. Here, a coordinate value group that indicates an outline of the color gamut of the ICC profile D1 in the device-dependent color space and the designated-color information D2 are input to the conversion section 13.

When the coordinate value group that indicates the outline of the color gamut of the ICC profile D1 in the device-dependent color space is input, the conversion section 13 generates, by performing the coordinate value conversion, a coordinate value group that indicates an outline of the color gamut of the ICC profile D1 in the device-independent color space. By using the generated coordinate value group, the display control section 11 causes the display device 200 to display a figure indicating the color gamut in the device-independent color space.

When the designated-color information D2 is input, the conversion section 13 generates, by performing the coordinate value conversion, coordinate values indicated by the designated-color information D2 in the device-independent color space. By using the generated coordinate values, the display control section 11 causes the display device 200 to display a dot indicating a designated color in the device-independent color space.

### 1-3. Operation of Image Processing Apparatus 1

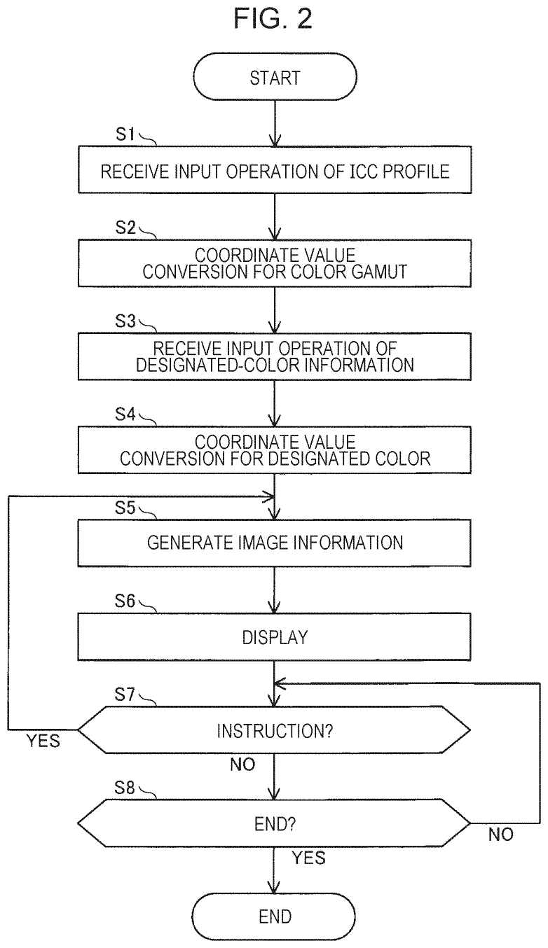

FIG. 2 is a flowchart of the image processing method according to the embodiment. The image processing method is performed by using the image processing apparatus 1. First, the image processing apparatus 1 receives an input operation of the ICC profile D1 in step S1. The input operation is performed by using the image GU described below.

The image processing apparatus 1 performs the coordinate value conversion for the color gamut of the ICC profile D1 in step S2. The coordinate value conversion is performed by the conversion section 13 as described above.

Next, the image processing apparatus 1 receives an input operation of the designated-color information D2 in step S3. The input operation is performed by using the image GU described below. Note that step S3 may be performed before step S2.

In step S4, the image processing apparatus 1 performs coordinate value conversion for a designated color indicated by the designated-color information D2. The coordinate value conversion is performed by the conversion section 13 as described above. Note that it is sufficient that step S4 be performed after step S3, and step S4 may be performed before step S2 when step S3 is performed before step S2.

Next, in step S5, the image processing apparatus 1 generates image information by using the information obtained in step S2, the information obtained in step S4, and the setting information D3. Generation is performed by the display control section 11.

In step S6, the image processing apparatus 1 causes the display device 200 to display an image according to the image information obtained in step S5. The display is performed in accordance with control performed by the display control section 11.

In step S7, the image processing apparatus 1 then determines whether or not an instruction from the receiving section 12 exists. The determination is made by the display control section 11.

When an instruction from the receiving section 12 exists, the image processing apparatus 1 returns to step S5 described above. As a result, the image changed in accordance with the instruction is displayed again on the display device 200 in step S6.

On the other hand, when no instruction from the receiving section 12 exists, the image processing apparatus 1 determines, in step S8, whether or not an instruction to end the processing has been issued. When no instruction to end the processing has been issued, the image processing apparatus 1 returns to step S7 described above. On the other hand, when an instruction to end the processing has been issued, the image processing apparatus 1 ends the processing.

In the image processing method described above, in step S6, the display control section 11 causes the display device 200 to display the image indicating the state in which the figure indicating the color gamut, a dot indicating a designated color, and one or more axes each indicating a feature amount of a color are viewed in an identical three-dimensional color space from a predetermined viewpoint. Moreover, in step S7, an instruction issued by the user is received. Furthermore, in step S6 after step S7, in accordance with the instruction, the image is changed upon changing the viewpoint. Hereinafter, the ICC profile D1 and the image will be described in detail.

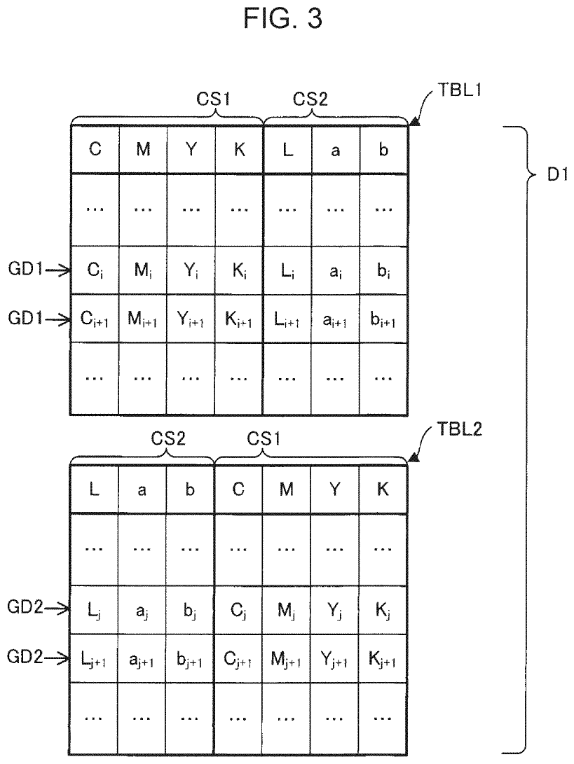

FIG. 3 is a diagram for explaining an example of the ICC profile D1. The ICC profile D1 includes, for example, information TBL1 and information TBL2 as illustrated in FIG. 3.

Each of the information TBL1 and the information TBL2 is information related to associations between coordinate values of a color space CS1 and coordinate values of a color space CS2. Note that the information TBL1 is an A2B table with which coordinate values (Cᵢ, Mᵢ, Yᵢ, Kᵢ) of the color space CS1 are converted into coordinate values (Lᵢ, aᵢ, bᵢ) of the color space CS2. A variable i is a variable with which lattice points GD1 set in the color space CS1 are identified. The lattice points GD1 are arrayed typically at regular intervals in the direction of each axis of the color space CS1. On the other hand, the information TBL2 is a B2A table with which coordinate values (Lⱼ, aⱼ, bⱼ) of the color space CS2 are converted into coordinate values (Cⱼ, Mⱼ, Yⱼ, Kⱼ) of the color space CS1. A variable j is a variable with which lattice points GD2 set in the color space CS2 are identified. The lattice points GD2 are arrayed typically at regular intervals in the direction of each axis of the color space CS2.

The color space CS1 is, for example, a device-dependent color space. FIG. 3 exemplifies a case in which the color space CS1 is a CMYK color space. On the other hand, the color space CS2 is a profile connection space (PCS) and, for example, a device-independent color space. FIG. 3 exemplifies a case in which the color space CS2 is the L*a*b* color space. Note that it is sufficient that the color space CS1 be a color space that an output device is able to use, and the color space CS1 is not limited to being a CMYK color space and may be, for example, a CMY color space or a color space unique to the output device. Moreover, it is sufficient that the color space CS2 be a device-independent color space, and the color space CS2 is not limited to being the L*a*b* color space and may be, for example, the XYZ color space.

For example, the above-described coordinate values (Cⱼ, Mⱼ, Yⱼ, Kⱼ) correspond to ink colors of the ink ejecting head 310 described above and indicate values corresponding to a use amount of ink of each color.

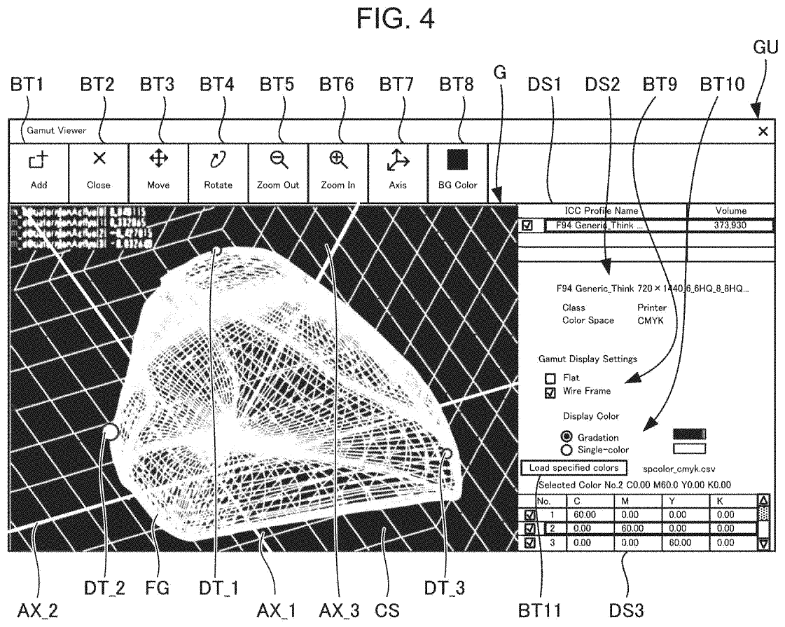

FIG. 4 illustrates an example of the image G to be displayed on the display device 200 by using the image processing apparatus 1. By executing the image processing program PG, the image processing apparatus 1 causes the display device 200 to display, as an application window, the image GU for the GUI which includes the image G, for example, as illustrated in FIG. 4. The display is performed by the display control section 11 described above.

The image G indicates a state in which a figure FG, dots DT_1 to DT_3, and axes AX_1 to AX_3 are viewed in an identical color space CS from a predetermined viewpoint. In the example illustrated in FIG. 4, the color space CS is the L*a*b* color space.

The figure FG is a figure indicating a shape of the color space CS2 in the information TBL1 described above and indicates the color gamut of the ICC profile D1. In the example illustrated in FIG. 4, the figure FG is displayed as a wire-frame model.

Each of the dots DT_1 to DT_3 indicates a designated color indicated by the designated-color information D2. In the example illustrated in FIG. 4, the dot DT_2 is emphatically displayed such that the dot DT_2 is displayed to be larger than the dot DT_1 and the dot DT_3. Note that each of the dots DT_1 to DT_3 may be referred to as the dot DT below. The number of dots DT is three in the example illustrated in FIG. 4 but may be two or less or four or more. Moreover, emphatic display is not limited to being performed in the manner of the example illustrated in FIG. 4 and may be performed by, for example, changing a color, a shape, or the like.

Each of the axes AX_1 to AX_3 indicates a feature amount of a color. Specifically, the axis AX_1 is an example of a first axis and indicates a hue. The axis AX_2 is an example of a second axis and indicates a hue that differs from that of the axis AX_1. The axis AX_3 indicates brightness. Since the color space CS is the L*a*b* color space as described above, the axes AX_1 to AX_3 are an L* axis, an a* axis, and a b* axis. For example, the axis AX_1 is the a* axis that indicates a change in color between green and red, the axis AX_2 is the b* axis that indicates a change in color between blue and yellow, and the axis AX_3 is the L* axis that indicates a change in brightness between white and black. Note that each of the axes AX_1 to AX_3 may be referred to as the axis AX below.

Here, although not shown for convenience in FIG. 4, each axis AX is displayed so as to indicate a feature amount of a color. For example, the axis AX_1 is displayed by using a color corresponding to the hue of the a* axis. The axis AX_2 is displayed by using a color corresponding to the hue of the b* axis. Note that, for example, the axis AX may be graduated to indicate a feature amount of a color.

Moreover, the image GU includes, in addition to the image G, buttons BT1 to BT11 and display sections DS1 to DS3 as display items related to the image G. Here, upon each operation of the buttons BT3 to BT10, the above-described instruction in step S7 illustrated in FIG. 2 is received by the receiving section 12.

The button BT1 is a button for inputting the ICC profile D1 serving as a display candidate. For example, upon operating the button BT1, a window in which a file of the ICC profile D1 is selected is displayed. One or more ICC profiles D1 added upon operating the button BT1 are displayed in the display section DS1. The display section DS1 illustrated in FIG. 4 has, for each of the ICC profiles D1, a checkbox for selecting whether or not to set the ICC profile D1 as a display target. Information of the ICC profile D1 selected by using the checkbox is displayed in the display section DS2. Moreover, upon selection with the checkbox, step S1 described above and illustrated in FIG. 2 is performed.

The button BT2 is a button for closing the application window of the image GU. Upon operating the button BT2, the above-described instruction to end the processing in step S8 illustrated in FIG. 2 is issued.

The button BT3 is a button for moving the figure FG in the image G. For example, when a drag operation is performed by using a mouse after the button BT3 is selected, the figure FG is moved in a direction of the drag operation.

The button BT4 is a button for rotating the figure FG in the image G. For example, when a drag operation is performed by using the mouse after the button BT4 is selected, the figure FG rotates about an axis orthogonal to a direction of the drag operation. Here, in accordance with the rotation of the figure FG, the color space CS, the dots DT, and the axes AX also rotate.

The button BT5 is a button for reducing the size of the figure FG in the image G. For example, each time the button BT5 is operated, the figure FG is reduced in size.

The button BT6 is a button for enlarging the figure FG in the image G. For example, each time the button BT6 is operated, the figure FG is enlarged.

The button BT7 is a button for setting the axes AX. For example, upon operating the button BT7, a window for performing a setting of whether or not to display the axes AX, a setting of colors of the axes AX, and the like is displayed.

The button BT8 is a button for setting a background color of the image G. For example, upon operating the button BT8, a color palette for setting the background color of the image G is displayed. In the example illustrated in FIG. 4, black is set as the background color of the image G. Moreover, in the example illustrated in FIG. 4, a lattice of the color space CS is displayed in the background of the image G.

The button BT9 is a button for settings related to display of the figure FG. Specifically, the button BT9 includes a checkbox for selecting whether or not to display the figure FG as a surface model and a checkbox for selecting whether or not to display the figure FG as a wire-frame model. In the example illustrated in FIG. 4, displaying the figure FG as a wire-frame model is selected.

The button BT10 is a button for settings related to the color of the figure FG when the figure FG is displayed as a surface model. Specifically, the button BT10 includes radio buttons for selecting whether to display the figure FG in gradations according to a color value or display the figure FG in a single color. In the example illustrated in FIG. 4, displaying the figure FG in gradations is selected. However, since displaying the figure FG as a wire-frame model is selected as described above, the function of the button BT10 is not exhibited.

The button BT11 is a button for inputting the designated-color information D2. For example, upon operating the button BT11, a window for selecting a file of the designated-color information D2 is displayed. It is possible to collectively input a plurality of designated colors by using a file format such as the CSV format for the file. The designated colors of the designated-color information D2 which are added upon operating the button BT11 are displayed in the display section DS3. The display section DS3 illustrated in FIG. 4 includes, for each designated color, a checkbox for selecting whether or not to set the designated color as a display target. The designated color selected by using the checkbox is displayed as the dot DT in the image G. Moreover, the display section DS3 enables the designated color to be selected. The dot DT corresponding to the selected designated color is emphatically displayed compared with the other dots DT.

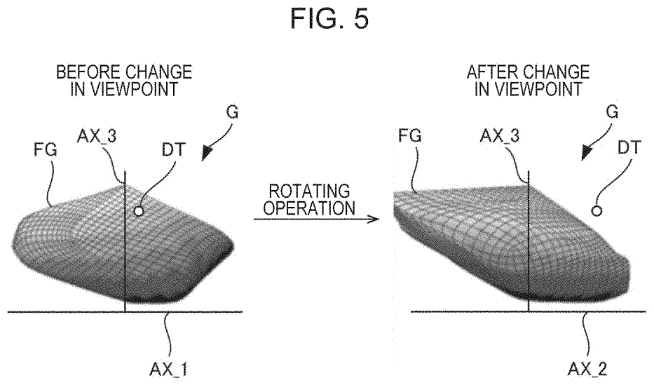

FIG. 5 is a schematic view for explaining a comparison between a color gamut and a designated color. FIG. 5 exemplifies two image G viewpoints which differ from each other by 90° about the axis AX_3. As in the image G illustrated on the left side in FIG. 5, when the dot DT and the figure FG are viewed from a viewpoint from which the dot DT appears to overlap the figure FG, it is difficult to know whether or not the designated color indicated by the dot DT is within the color gamut indicated by the figure FG. Even when it is shown that the designated color indicated by the dot DT is not within the color gamut indicated by the figure FG, it is difficult to know the extent to which the designated color deviates from the color gamut.

On the other hand, when the viewpoint is changed by using the above-described button BT4 and when, as in the image G illustrated on the right side in FIG. 5, the dot DT and the figure FG are viewed from a viewpoint from which the dot DT does not appear to overlap the figure FG, it is shown that the designated color indicated by the dot DT is not within the color gamut indicated by the figure FG. Moreover, when the axes AX are also observed together, it is easy to understand the extent to which the designated color deviates from the color gamut.

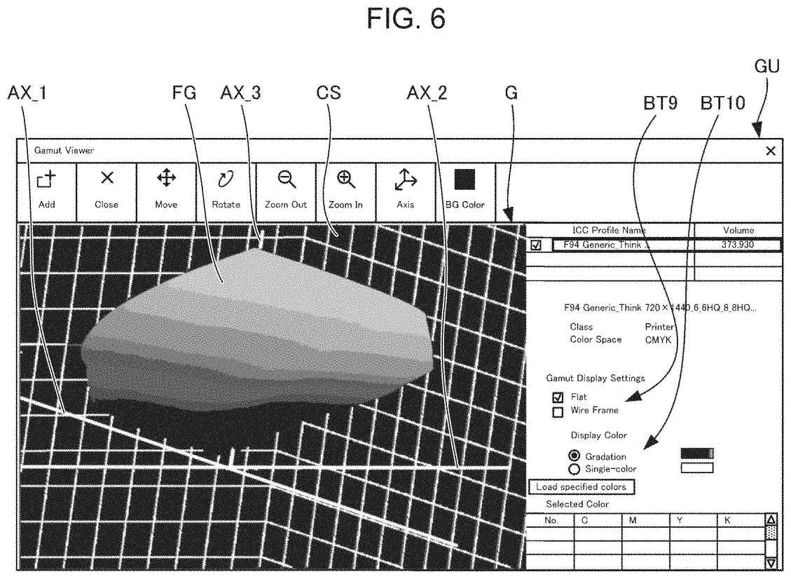

FIG. 6 illustrates an example of the image G in which the color gamut is displayed as a surface model. FIG. 6 exemplifies the figure FG displayed as a surface model in accordance with operation of the button BT9 described above. In the example illustrated in FIG. 6, the figure FG is displayed in gradations according to a color value of the outline of the color gamut by using the button BT10. Note that, in the example illustrated in FIG. 6, since the designated-color information D2 is not input, no dot DT is displayed.

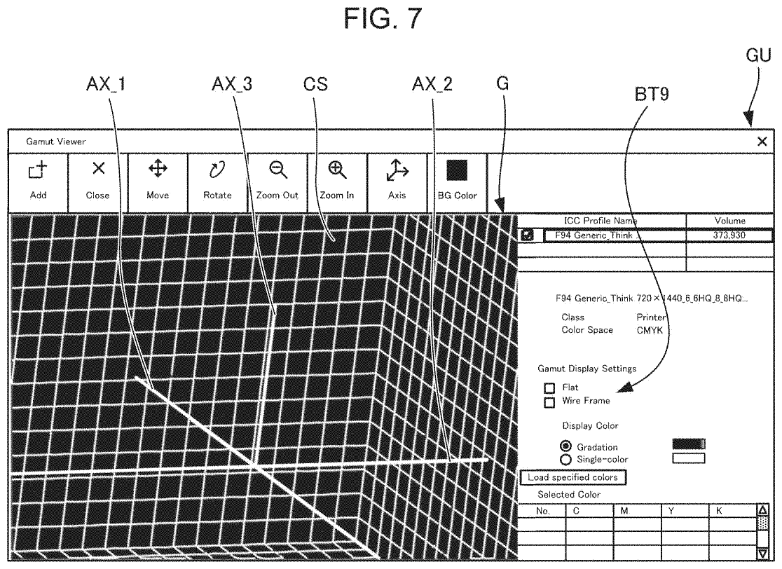

FIG. 7 illustrates an example of the image G when the color gamut is not displayed. FIG. 7 exemplifies a case in which the above-described button BT9 is used so as not to display the figure FG. Note that, in the example illustrated in FIG. 7, since the designated-color information D2 is not input, no dot DT is displayed.

As described above, the aforementioned image processing apparatus 1 includes the display control section 11 and the receiving section 12. The display control section 11 causes the display device 200 to display the image G. The image G indicates the state in which the figure FG indicating the color gamut, the dot DT indicating a designated color, and one or more axes AX each indicating a feature amount of a color are viewed in an identical three-dimensional color space CS from a predetermined viewpoint. The receiving section 12 receives an instruction issued by a user. In accordance with the instruction from the receiving section 12, the display control section 11 changes the image G upon changing the viewpoint indicated by the image G.

In the above-described image processing apparatus 1, since the figure FG and the dot DT are illustrated in an identical color space CS in the image G displayed on the display device 200, a user is able to determine whether or not a designated color is within the color gamut by observing the figure FG and the dot DT. Moreover, since, in addition to the figure FG and the dot DT, one or more axes AX are illustrated in an identical color space CS in the image G displayed on the display device 200, by observing the axes AX together with the figure FG and the dot DT, the user is also able to determine the extent to which the designated color deviates from the color gamut when the designated color is not within the color gamut. Furthermore, since, in accordance with the instruction issued by the user, the image G is changed upon changing the viewpoint, it is possible to change the image G such that the user is easily able to see the positional relationship between the figure FG and the dot DT which are illustrated in the image G, thereby improving the speed and simplicity of the above-described determination.

As described above, the one or more axes AX include the axis AX_1 which is an example of the first axis, the axis AX_2 which is an example of the second axis, and the axis AX_3 which is an example of a third axis. Each of the axis AX_1 and the axis AX_2 is an axis indicating a hue. Note that each of the axis AX_1 and the axis AX_2 indicates a different range of hues. The axis AX_3 is an axis indicating brightness.

In the present embodiment, in the image G, it is desirable that the axis AX_1 be indicated in a color corresponding to the hue indicated by the axis AX_1 and that the axis AX_2 be indicated in a color corresponding to the hue indicated by the axis AX_2, as described above.

In this manner, when a designated color is not within the color gamut, a user is able to determine the extent to which a hue of the designated color deviates from the color gamut by using the axis AX_1 and the axis AX_2 which indicate the hue. Particularly, since each of the axis AX_1 and the axis AX_2 is indicated in the color corresponding to the hue indicated by the axes, there is an advantage in that the user is able to easily and visually understand the extent to which the hue of the designated color deviates from the color gamut.

Moreover, as described above, the image processing apparatus 1 further includes the conversion section 13. The conversion section 13 converts the designated-color information D2 related to a designated color from coordinate values of an RGB color space or a CMYK color space into coordinate values of the L*a*b* color space by using the ICC profile D1 having a target color gamut. The display control section 11 causes the display device 200 to display the image G by using information converted by the conversion section 13. It is thus possible to determine whether or not the designated color indicated by the designated-color information D2 is within the color gamut of the ICC profile D1.

As described above, in accordance with the instruction from the receiving section 12, the display control section 11 changes the background color of the image G. This makes it easy for the user to see the figure FG, the dot DT, and the axes AX, thus facilitating a comparison therebetween. For example, when the axis AX_1 and the axis AX_2 which indicate hues are indicated in colors corresponding to the hues indicated by the axes, a difference between the hue related to deviation of a designated color from the color gamut and the background color makes it easy for the user to determine the deviation of the hue.

Moreover, as described above, in accordance with the instruction from the receiving section 12, the display control section 11 switches between displaying and not displaying the figure FG as a wire-frame model. When the figure FG is displayed as a wire-frame model, the dot DT is prevented from being hidden by the figure FG, and thus there is an advantage in that it is easy to grasp the relationship between the figure FG and the dot DT. Moreover, by switching between displaying and not displaying the figure FG as a wire-frame model, it is possible to change easiness of seeing the figure FG and the dot DT in accordance with an intention of the user.

Furthermore, as described above, in accordance with the instruction from the receiving section 12, the display control section 11 switches between displaying and not displaying the figure FG as a surface model. When the figure FG is displayed as a surface model, the dot DT positioned outside the figure FG is readily seen. Moreover, when a color corresponding to the hue of the color gamut is used for the figure FG, there is also an advantage in that it is easy to understand characteristics of the color gamut. Furthermore, by switching between displaying and not displaying the figure FG as a surface model, it is possible to change easiness of seeing the figure FG and the dot DT in accordance with an intention of the user.

Moreover, as described above, in accordance with the instruction from the receiving section 12, the display control section 11 changes a color of the figure FG. Thus, for example, using a color corresponding to the hue of the color gamut for the figure FG enables the user to easily and visually understand the characteristics of the color gamut.

Furthermore, as described above, in accordance with the instruction from the receiving section 12, the display control section 11 emphatically displays the dot DT which is selected by the user compared with a dot DT which is not selected. It is thus possible to facilitate viewing the dot DT which is to be compared with the figure FG. Particularly, when a plurality of dots DT such as the dot DT_1, the dot DT_2, and the dot DT_3 are included as in the present embodiment, it is easy to see which dot is to be compared with the figure FG.

Moreover, as described above, in accordance with the instruction from the receiving section 12, the display control section 11 enlarges or reduces the image FG. Accordingly, a comparison between the figure FG and the dot DT becomes easy. For example, when the figure FG is enlarged, it is possible to specifically know deviation of the dot DT from the figure FG. Moreover, when the size of the figure FG is reduced, it is possible to facilitate finding the dot DT in the image G.

Furthermore, as described above, the color space CS is the L*a*b* color space. The L*a*b* color space is designed so as to be closely related to a human visual sense. Thus, by using the L*a*b* color space as the color space CS, a comparison between the color gamut and a designated color becomes easier for the user compared with a case in which another color space is used.

### 2. MODIFIED EXAMPLE

Each form exemplified above can be variously modified. Specific modified aspects applicable to each of the above-described forms will be exemplified below. Note that two or more aspects selected from the following exemplification can be appropriately combined within a range in which they do not contradict each other.

Although the configuration in which the color space CS illustrated by the image G is the L*a*b* color space is exemplified in the above-described forms, the color space CS is not limited to being the L*a*b* color space and may be, for example, the XYZ color space.

Moreover, a feature amount of a color indicated by the axis AX is appropriately changed in accordance with a type of the color space CS. That is, a feature amount of a color indicated by the axis AX is not limited to hue or brightness and may be, for example, saturation or tristimulus values.

The number of axes AX illustrated in the image G is not limited to three and may be two or less or four or more.

Moreover, although the configuration in which the image processing program PG is installed in a computer such as a personal computer is exemplified in the above-described forms, the configuration is not limited thereto. For example, the image processing program PG may be installed in an output device such as a printer or in portable equipment such as a tablet terminal or a smartphone.

What is claimed is:

1. An image processing apparatus comprising:
a display control section that causes a display device to display an image indicating a state in which a figure indicating a color gamut, a dot indicating a designated color, and one or more axes each indicating a feature amount of a color are viewed in an identical three-dimensional color space from a predetermined viewpoint; and
a receiving section that receives an instruction issued by a user, wherein
the display control section changes, in accordance with the instruction, the image upon changing the viewpoint.

2. The image processing apparatus according to claim 1, wherein
the one or more axes include an axis indicating brightness.

3. The image processing apparatus according to claim 1, wherein
the one or more axes include an axis indicating a hue, and
the image indicates the axis in a color corresponding to the hue indicated by the axis.

4. The image processing apparatus according to claim 1, wherein
the one or more axes include a first axis, a second axis, and a third axis,
the first axis is an axis indicating a hue,
the second axis is an axis indicating a hue which differs from the hue of the first axis,
the third axis is an axis indicating brightness, and
the image
indicates the first axis in a color corresponding to the hue indicated by the first axis and
indicates the second axis in a color corresponding to the hue indicated by the second axis.

5. The image processing apparatus according to claim 1, further comprising
a conversion section that converts designated-color information related to the designated color from coordinate values of an RGB color space or a CMYK color space into coordinate values of the L*a*b* color space by using an ICC profile having the color gamut, wherein
the display control section causes the display device to display the image by using the information converted by the conversion section.

6. The image processing apparatus according to claim 1, wherein
the display control section changes a background color of the image in accordance with the instruction.

7. The image processing apparatus according to claim 1, wherein
the display control section switches, in accordance with the instruction, between displaying and not displaying the figure as a wire-frame model.

8. The image processing apparatus according to claim 1, wherein
the display control section switches, in accordance with the instruction, between displaying and not displaying the figure as a surface model.

9. The image processing apparatus according to claim 1, wherein
the display control section changes a color of the figure in accordance with the instruction.

10. The image processing apparatus according to claim 1, wherein
the display control section emphatically displays, in accordance with the instruction, the dot selected by the user compared with a case in which the dot is not selected.

11. The image processing apparatus according to claim 1, wherein
the display control section enlarges or reduces the figure in accordance with the instruction.

12. The image processing apparatus according to claim 1, wherein
the color space is the L*a*b* color space.

13. An image processing method comprising:
causing a display device to display an image indicating a state in which a figure indicating a color gamut, a dot indicating a designated color, and one or more axes each indicating a feature amount of a color are viewed in an identical three-dimensional color space from a predetermined viewpoint;
receiving an instruction issued by a user; and
changing, in accordance with the instruction, the image upon changing the viewpoint.

14. A non-transitory computer-readable storage medium storing an image processing program, the image processing program causing a computer to execute:
causing a display device to display an image indicating a state in which a figure indicating a color gamut, a dot indicating a designated color, and one or more axes each indicating a feature amount of a color are viewed in an identical three-dimensional color space from a predetermined viewpoint;
receiving an instruction issued by a user; and
changing, in accordance with the instruction, the image upon changing the viewpoint.
